(19) United States
(12) Patent Application Publication
(10) Pub. No.: US 2007/0246340 A1
(43) Pub. Date: Oct. 25, 2007

(54) PIVOT SWITCH MECHANISM FOR ELECTRONIC DEVICE

(75) Inventors: XIANG-GUO ZHAO, Shenzhen (CN); XIAO-LIANG WEI, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: SHENZHEN FUTAIHONG PRECISION INDUSTRIAL CO,.LTD., Shenzhen (CN); Sutech Trading Limited, Tortola (VG)

(21) Appl. No.: 11/564,270

(22) Filed: Nov. 28, 2006

(30) Foreign Application Priority Data
Apr. 21, 2006 (CN) 200610060409.8

(51) Int. Cl. H01H 13/00

(52) U.S. Cl. 200/339

(57) ABSTRACT

A pivot switch mechanism (200) mounted on a shell (20) of an electronic device (300) includes a fixing portion (30) and an operating portion (40). The fixing portion (30) is mounted on the shell (20) and is connected with the operating portion (40) in a spring-biased manner. The fixing portion (30) defines a receiving hole (32) and two receiving grooves (28). The operating portion (40) includes two resisting columns (48) and at least one pivotal shaft (424). The operating portion (40) is located in the receiving hole (32). The at least one pivotal shaft (424) is received in the receiving grooves (28). When the operating portion (40) is pressed, the operating portion (40) rotates/pivots relative to the receiving grooves (28) via the at least one pivotal shaft (424). When the pressure on the operating portion (40) is released, the operating portion (40) returns to its original position.

### BACKGROUND OF THE INVENTION

1. Field of the Invention

The present invention generally relates to button mechanisms for electronic devices and, more particularly, to a pivot switch mechanism for an electronic device.

2. Description of related art

Nowadays, electronic devices such as mobile phones, digital video cameras, radios, etc. have all entered widespread use and bring much convenience to our daily lives. Pivot switch mechanisms are widely used in these electronic devices for adjusting an output level, e.g., sound volume or sound frequency.

FIGS. 5-6 show a typical pivot switch mechanism 100 for an electronic device (not labeled). The electronic device has a shell 12 and two circuit loops (not shown) inside the shell 12. The pivot switch mechanism 100 is fixed to the shell. The pivot switch mechanism 100 includes an operating member 14 and two holding members 16. The operating member 14 is mounted to the shell 12 by means of the holding members 16. The shell 12 has a fixing hole 122 and has two fixing grooves 124 defined therein. Each one of the two fixing grooves 124 are positioned at a respective one of the two opposite sides of the fixing hole 122, and each fixing groove 124 extends to the fixing hole 122. The four positioning posts 126 are symmetrically located on the periphery of the fixing hole 122, with two positioning posts 126 located at either side of each fixing groove 124. The operating member 14 includes a body 142, two pivotal shafts 144 extending coaxially from the body 142 in opposite directions, and two resisting columns 146. The resisting columns 146 are positioned opposite to each other. Each holding member 16 has a receiving groove 162 and two positioning holes 164 defined therein. The two positioning holes 164 are located opposite to each other on either side of the receiving groove 162. The positioning holes 164 are engaged with the positioning posts 126.

In assembly, firstly, the operating member 14 is located in the fixing hole 122 with the pivotal shafts 144 being held in the fixing grooves 124. Then the two holding members 16 are respectively disposed on the shell 12 with the positioning posts 126 passing into/through the positioning holes 164. Thus, the operating member 14 is rotatably/pivotably fixed on the shell 12 by means of the holding members 16.

The pivot switch mechanism 100 can be used to selectively connect one of the circuit loops via the operating member 14 by rotating relative to the pivotal shafts 144. However, the pivot switch mechanism 100 includes a lot of individual parts. As such, the costs associated therewith, in terms of the money and time needed to manufacture and assemble these individual parts, are restrictive.

What is needed, therefore, is a pivot switch mechanism that can overcome the above mentioned shortcomings.

### SUMMARY OF THE INVENTION

In one embodiment, a pivot switch mechanism mounted on a shell of an electronic device includes a fixing portion mounted on the shell and an operating portion. The fixing portion is integrally formed with the operating portion. The fixing portion defines therein a receiving hole and two receiving grooves. The receiving hole is a through hole. The two receiving grooves are coaxial with one another, and each communicates with the receiving hole. The operating portion includes two resisting columns and at least one pivotal shaft. The operating portion is located in the receiving hole. The at least one pivotal shaft is pivotably received in a corresponding receiving groove. The operating portion is connected to the fixing portion via a biasing mechanism. When the operating portion is pressed, the operating portion rotates relative to the receiving grooves via the at least one pivotal shaft, and when the pressure on the operating portion is released, the operating portion returns to its original position under a force generated by the biasing mechanism.

Other advantages and novel features will become more apparent from the following detailed description when taken in conjunction with the accompanying drawings.

### BRIEF DESCRIPTION OF THE DRAWINGS

Many aspects of the pivot switch mechanism can be better understood with reference to the following drawings. The components in the drawings are not necessarily drawn to scale, the emphasis instead being placed upon clearly illustrating the principles of the present mechanism. Moreover, in the drawings, like reference numerals designate corresponding parts throughout the several views.

FIG. 1 is a schematic view of an electronic device incorporating a pivot switch mechanism, in accordance with a preferred embodiment;

FIG. 2 is similar to FIG. 1, but showing another aspect;

FIG. 3 is similar to FIG. 2, but showing the pivot switch mechanism mounted on a shell of the electronic device;

FIG. 4 is an isometric, inverted, cut-away view of the pivot switch mechanism mounted on the shell in FIG. 3;

FIG. 5 is a exploded schematic view of an electronic device employing a typical pivot switch mechanism; and

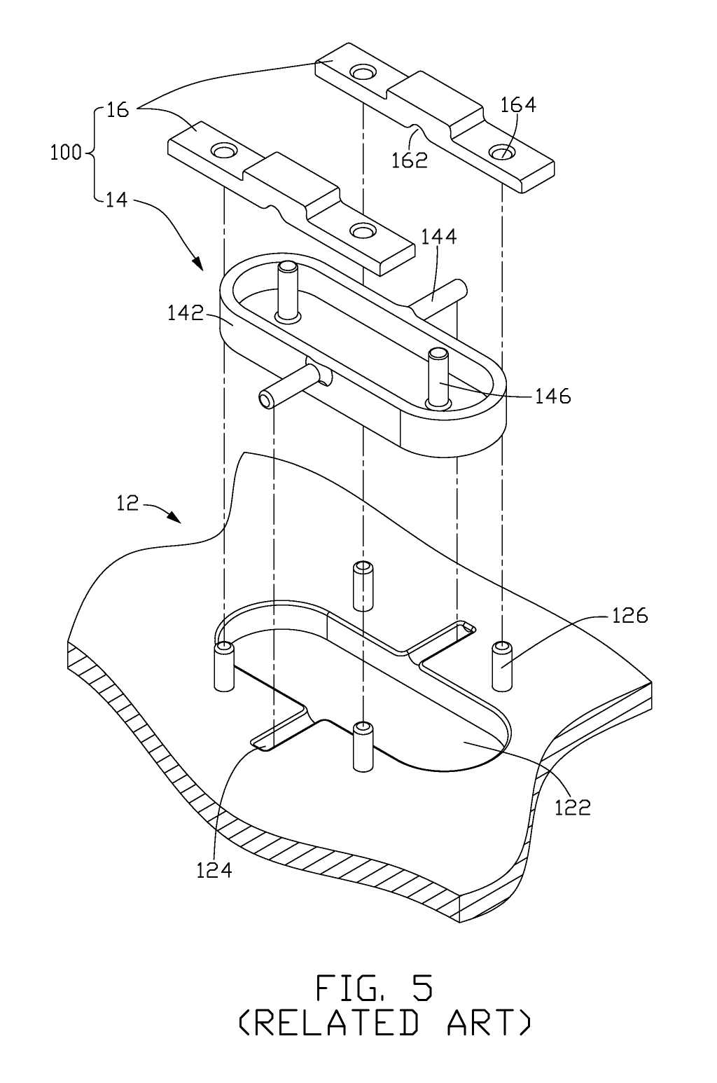

FIG. 6 is a cutaway view of the electronic device of FIG. 5, the pivot switch mechanism being mounted on a shell of the electronic device.

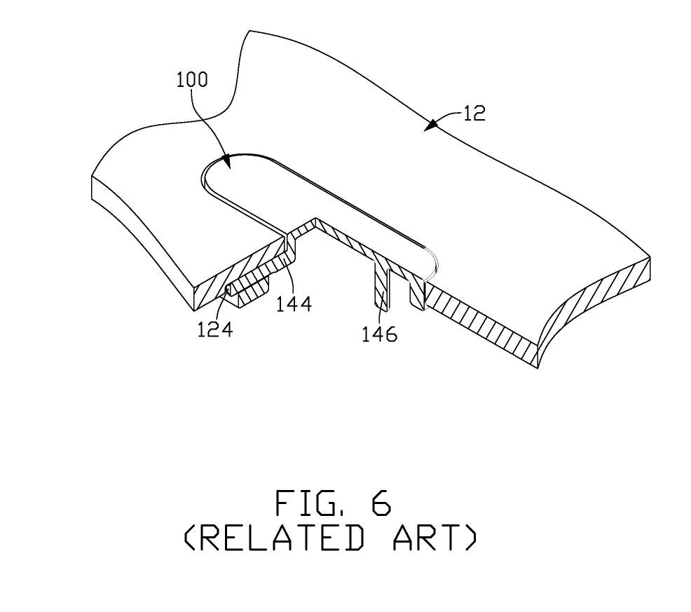

### DETAILED DESCRIPTION OF THE INVENTION

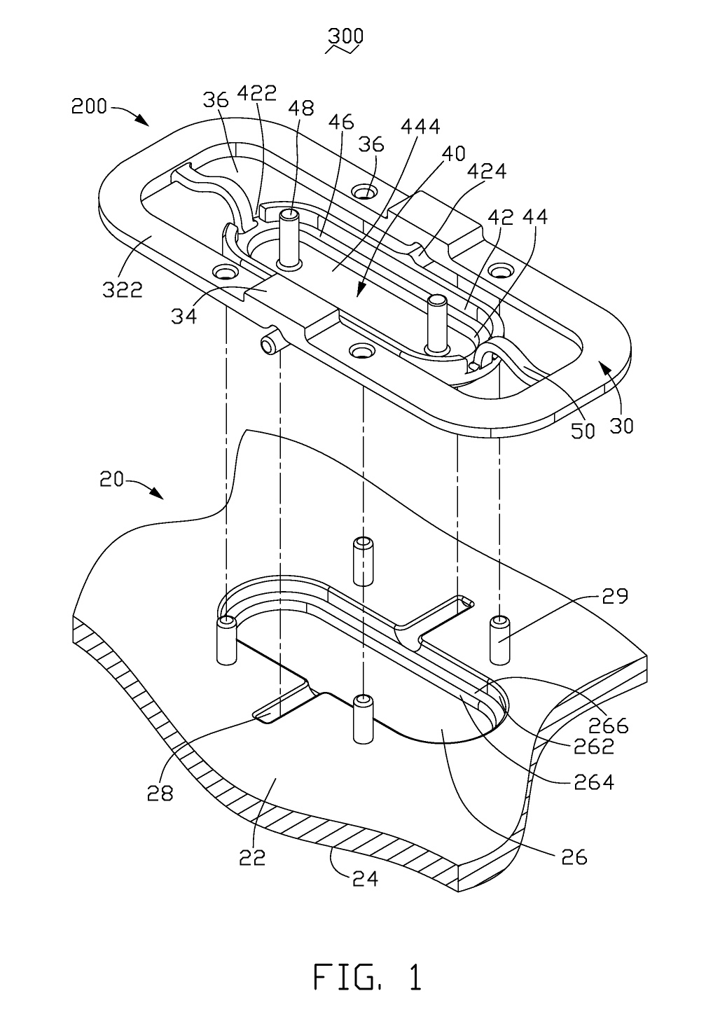

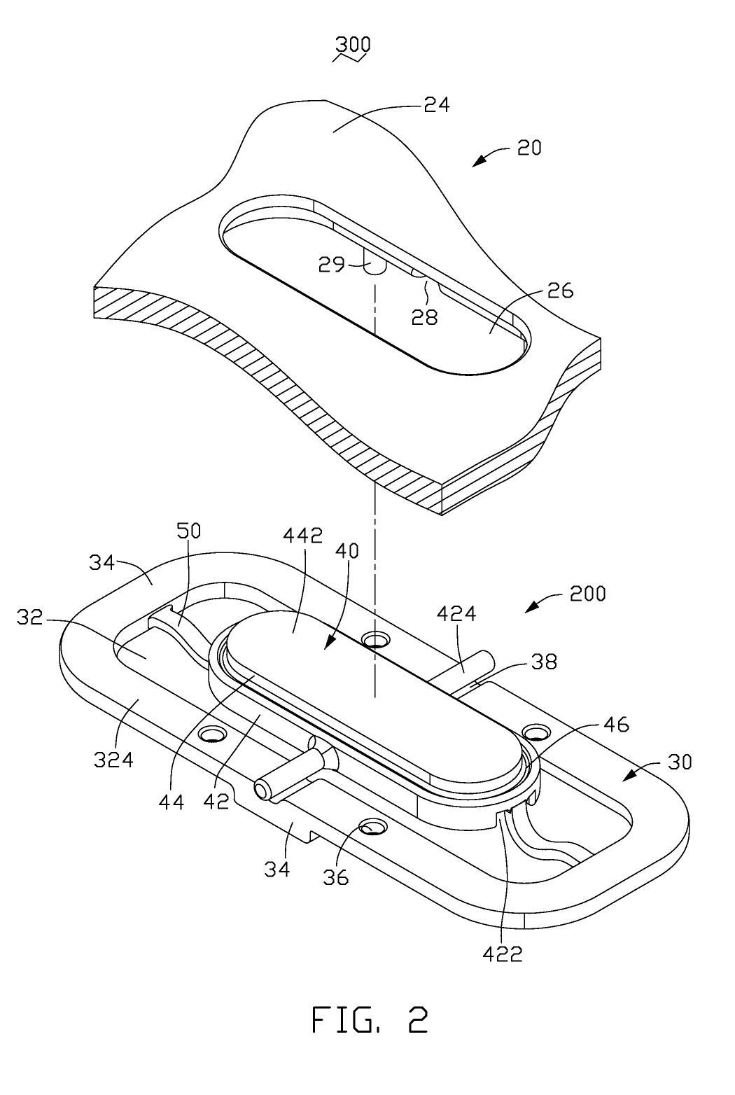

FIGS. 1-2 show a pivot switch mechanism 200 used in an electronic device 300, e.g., a sound-producing device. It is, however, to be understood that such a pivot switch mechanism 200 could potentially be employed in any of a variety of electrical devices (e.g., electronics, lighting, power tools, etc.) in which switches are advantageously employed, either to adjust an output level or to choose an on/off state. The electronic device 300 includes a shell 20 and a printed circuit board (PCB, not shown) in the shell 20. The printed circuit board has two circuit loops, in which, e.g., one circuit loop is used to increase sound volume and another circuit loop is used to reduce sound volume. It is to be understood that each loop could instead be used to control, e.g., on/off, power level, etc., depending on the particular use environment of the pivot switch mechanism 200. Each circuit loop has a gap to allow selective operative connection with the pivot switch mechanism 200.

The shell 20 has a first surface 22 and a second surface 24 opposite to the first surface 20. A fixing hole 26 is defined in the shell 20 through the first surface 22 and the second surface 24. The fixing hole 26 is cooperatively formed/bounded by two oval walls 262, 264, and a flat surface 266. The flat surface 266 interconnects the oval walls 262, 264 and is located therebetween. The flat surface 266 is mutually orthogonal to the oval walls 262, 264. The shell 20 has two coaxial fixing grooves 28 defined therein. The two fixing grooves 28 are located at the two opposite sides of the fixing hole 26, respectively, and each fixing groove 28 extends to communicate with the fixing hole 26. Four positioning posts 29 are formed on the same side of the shell 20 with the fixing grooves 28. The four positioning posts 29 are symmetrically located on the periphery of the fixing hole 26, and a positioning post 29 is located either side of each fixing groove 28. It is, however, to be understood that the number and/or arrangement of the positioning posts 29 could be varied and still be within the scope of the present embodiment.

The pivot switch mechanism 200 may, advantageously, be made of a durable, resilient polymer, e.g., a plastic such as acrylonitrile-butadiene-styrene (ABS), polyurethane, or acryl. The pivot switch mechanism 200 includes a fixing portion 30, an operating portion 40 integrally formed with the fixing portion 30, and two curved strips 50 connecting the fixing portion 30 with the operating portion 40 in a biased fashion.

The fixing portion 30 is annular-shaped and defines a receiving hole 32 therein. The fixing portion 30 has an upper surface 322 and an opposite lower surface 324. Two blocks 34 protrude from the upper surface 322 and are located symmetrically opposite to each other. The fixing portion 30 has four positioning holes 36 defined therein. The four positioning holes 36 are symmetrically located on the periphery of the block 34, essentially defining four corners of a rectangle. Two receiving grooves 38, directly opposed across the receiving hole 32 and essentially linearly aligned with one another, are defined in the lower surface 324.

The operating portion 40 is a generally step-shaped shell and is configured (i.e., structured and arranged) to be received in the receiving hole 32. The operating portion 40 includes a base 42, a pressing projection 44, and a protecting board 46 connected with the base 42 and the pressing projection 44. The protecting board 46 helps to prevent contaminants, such as dust and/or water, from entering into the shell 20. The base 42 is preferably an annular wall and has two openings 422 defined through the two opposite ends thereof. Two opposite pivotal shafts 424 protrude from the middle portion of the base 42, in linearly opposite directions. Each pivotal shaft 424 is configured for being received in the fixing grooves 28 and the receiving grooves 38. The pressing projection 44 has a pressing surface 442 and an opposite inner surface 444. Two resisting columns 48 protrude from the inner surface 444 and extend out of the base 42. The two resisting columns 48 are symmetrically located on the two sides of the pivotal shafts 424. Each resisting column 48, respectively, corresponds to one of the gaps in the two circuit loops.

The curved/bias strips 50 generally have a bent, angled, or otherwise curved configuration. Such a configuration allows the curved strips 50 to exhibit a spring bias (i.e., to act as a spring) and, thus, an inherent tendency to return to an initial shape/position after a force is released therefrom. Each curved strip 50 has two ends, of which one end connects with the curved plane 34 of the fixing portion 30. The other end connects with the base 42 via the opening 422. As such, each receiving groove 38 is positioned under its corresponding pivotal shaft 424.

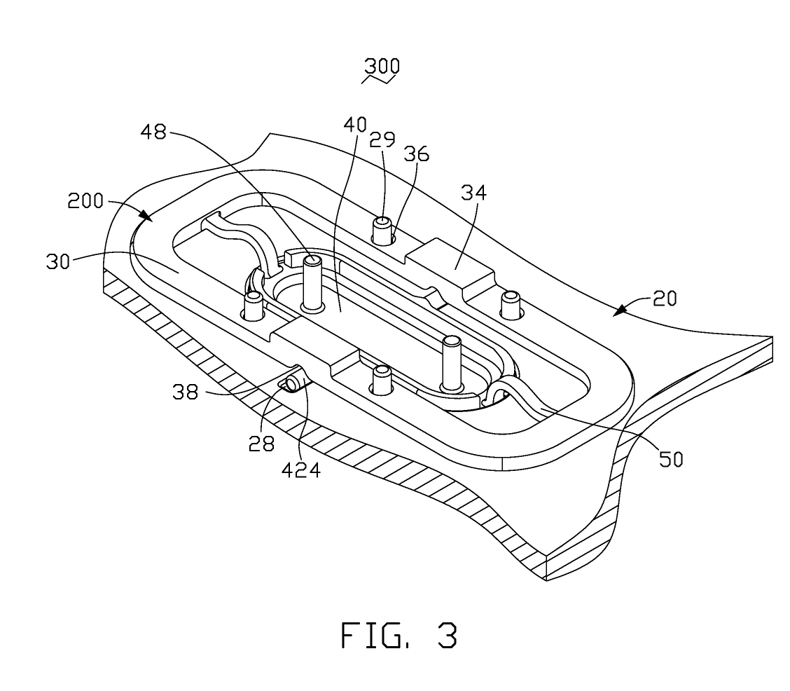

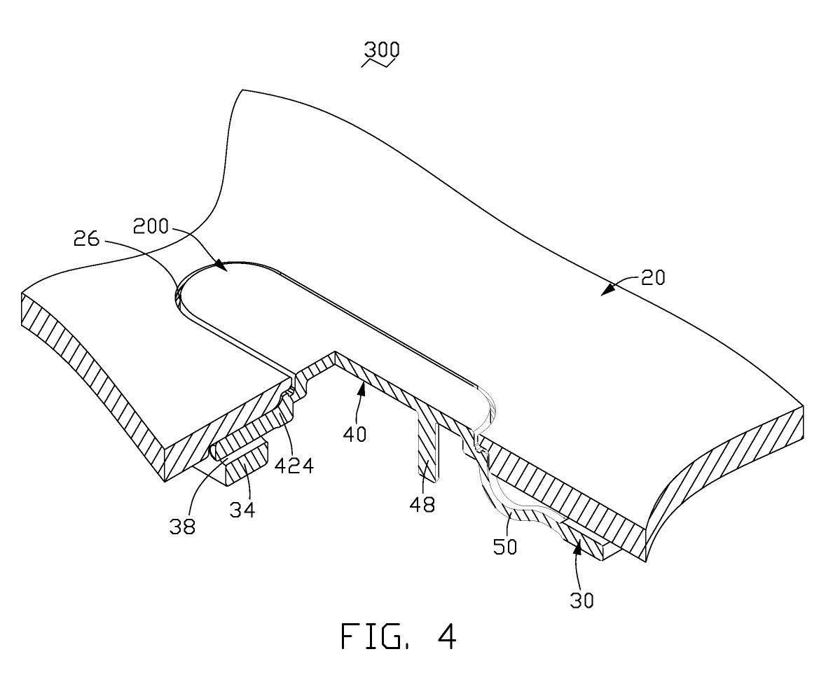

Referring to FIGS. 3-4, in assembly, the positioning posts 29 are aligned with the positioning holes 36. The operating portion 40 is engaged in the fixing hole 26, and the protecting board 46 resists (i.e., bears against) the flat surface 266, the pressing surface 442 of the operating portion 40 is exposed through the fixing hole 26, and each shaft 424 is rotatably received in a respective space formed by a corresponding pair of the fixing grooves 28 and the receiving grooves 38. The ends of each of the positioning posts 29 are advantageously melted/welded or soldered to allow the permanent attachment thereof to the fixing portion 30, so that the pivot switch mechanism 200 is fixed to the shell 20. Since each resisting column 48 corresponds to a circuit loop and as the operating portion 40 can rotate/pivot relative to the shell 20, the circuit loops can be selectively connected.

In use, by pressing one end of the pressing surface 442 of the operating portion 40, the curved strips 50 undergo a change in their original shape (i.e., the change being a source of spring potential energy), and the pivotal shafts 424 resist the shell 20 in the first grooves and rotate. The resisting column 48 associated with the end being pressed then moves inside and electrically connects the circuit loop. That connection permits a characteristic/level to be adjusted (e.g., sound volume is increased or reduced) or a component to be turned on or off, depending on the nature of the switch. When the pressure on the pressing surface 442 is released, the curved strips 50 rebound to their original configuration. Due to this rebounding action, the operating portion is returned to its initial location, and the resisting column 48 leaves the gap in the circuit loop and returns to its original position. It is to be understood, however, that any spring configuration that generates the required rebounding action would be within the scope of the present spring element.

It can be easily understood that the assembly of the pivot switch mechanism 200 to the shell 20 is facilitated by the pivot switch mechanism 200 being a single member.

In further alternative embodiments, the operating portion can be a solid body; the two pivotal shafts 424 can instead be integrally formed as a pivotal shaft; and/or the fixing portion 30 can be fixed to the shell 20 by means of screw threading or an adhesive. Additionally, more than two curved strips 50 (e.g., four) could be employed for increased connection stability. If more than two strips 50 are employed, they are advantageously used at opposed ends (e.g., a pair at each end) of the operating portion 40, as in the illustrated two-strip embodiment.

It should be understood that the pivot switch mechanism can easily be used for purposes other than changing volume, such as, for example, changing brightness of a visual display, changing light strength for a light source, changing channels in a radio system, turning a component on/off, etc.

It is believed that the present embodiments and their advantages will be understood from the foregoing description, and it will be apparent that various changes may be made thereto without departing from the spirit and scope of the invention or sacrificing all of its material advantages, the examples here before described merely being preferred or exemplary embodiments of the invention.

1. A pivot switch mechanism mounted on a shell of an electronic device, comprising:
a fixing portion mounted on the shell, the fixing portion defining a receiving hole and two receiving grooves, the receiving hole being a tbrough hole, the two receiving grooves being positioned at two opposite sides of the fixing portion and communicating with the receiving hole; and
an operating portion including two resisting columns and at least one pivotal shaft, the operating portion being located in the receiving hole, the at least one pivotal shaft being positioned relative a corresponding receiving groove;
wherein the fixing portion is biasingly connected with the operating portion, the operating portion is moveable relative to the fixing portion, and the at least one pivotal shaft is pivotably held relative the receiving hole.

2. The pivot switch mechanism as claimed in claim 1, wherein the shell defines a fixing hole configured for receiving the operating portion and further defines two fixing grooves configured for pivotably receiving the at least one pivotal shaft.

3. The pivot switch mechanism as claimed in claim 1, further comprising two curved strips connecting with the fixing portion and the operating portion, each of the curved strips being configured to act as a spring element.

4. The pivot switch mechanism as claimed in claim 1, wherein the operating portion comprises a base, a pressing projection, and a protecting board connecting with the base and the pressing projection, the at least one pivotal shaft thereby extending from the base.

5. The pivot switch mechanism as claimed in claim 4, wherein the shell defines a step-shaped fixing hole matching a shape of the operating portion.

6. The pivot switch mechanism as claimed in claim 4, wherein the at least one pivotal shaft comprises two pivotal shafts, the pivotal shafts being located symmetrically opposite to each other.

7. The pivot switch mechanism as claimed in claim 4, wherein the pivot switch mechanism further comprises two curved strips, the base of the operating portion defines two openings, and the curved strips connect the fixing portion and the operating portion via the openings.

8. The pivot switch mechanism as claimed in claim 1, wherein the pivot switch mechanism is made of a resilient plastic material.

9. A pivot switch mechanism mounted on a shell of an electronic device, comprising:
a fixing portion mounted on the shell, the fixing portion defining a receiving hole and two receiving grooves, the receiving hole being a through hole, the two receiving grooves being positioned at two opposite sides of the fixing portion and communicating with the receiving hole;
an operating portion including two resisting columns and at least one pivotal shaft, the operating portion located in the receiving hole, the at least one pivotal shaft being received in at least one corresponding receiving groove; and
at least two curved strips connecting with the fixing portion and operating portion;
wherein the fixing portion, the curved strips, and the operating portion are all molded as a single piece unit, when the operating portion is pressed, the curved strips change their original shape, and when the pressure on the operating portion is released, the curved strips rebound to their original configuration, thereby returning the operating portion to an initial position thereof.

10. The pivot switch mechanism as claimed in claim 9, wherein the shell defines a fixing hole configured for receiving the operating portion and two fixing grooves for receiving the at least one pivotal shaft.

11. The pivot switch mechanism as claimed in claim 9, wherein the operating portion comprises a base, a pressing projection, and a protecting board connecting with the base and the pressing projection, the at least one pivotal shaft thereby extending from the base.

12. The pivot switch mechanism as claimed in claim 1, wherein the shell defines a step-shaped fixing hole matching a shape of the operating portion.

13. The pivot switch mechanism as claimed in claim 1, wherein the base of the operating portion defines two openings, and the curved strips connect the fixing portion and the operating portion via the openings.

14. The pivot switch mechanism as claimed in claim 1, wherein the at least one pivotal shaft comprises two pivotal shafts, the pivotal shafts being located symmetrically opposite to each other.

15. The pivot switch mechanism as claimed in claim 1, wherein the base of the operating portion defines two openings, and the curved strips connect the fixing portion and the operating portion via the openings.

16. The pivot switch mechanism as claimed in claim 9, wherein the pivot switch mechanism is made of a resilient plastic material.

17. The pivot switch mechanism as claimed in claim 1, wherein the fixing portion is integrally formed with the operating portion.

18. The pivot switch mechanism as claimed in claim 1, wherein the fixing portion is annular-shaped, two blocks protrude from an upper surface of the fixing portion, and the two receiving grooves are defined in a lower surface of the fixing portion and respectively corresponding to the two blocks.

19. The pivot switch mechanism as claimed in claim 9, wherein the fixing portion is annular-shaped, two blocks protrude from an upper surface of the fixing portion, and the two receiving grooves are defined in a lower surface of the fixing portion and respectively corresponding to the two blocks.
